(19) United States
(12) Patent Application Publication
(10) Pub. No.: US 2011/0299103 A1
(43) Pub. Date: Dec. 8, 2011

(54) IMAGE PROCESSING APPARATUS, DATA TRANSMISSION SYSTEM, AND IMAGE PROCESSING METHOD

(75) Inventor: Keiko Kanamori, Shizuoka-ken (JP)

(73) Assignees: TOSHIBA TEC KABUSHIKI KAISHA, Tokyo (JP); KABUSHIKI KAISHA TOSHIBA, Minato-ku (JP)

(21) Appl. No.: 13/118,853

(22) Filed: May 31, 2011

Related U.S. Application Data
(60) Provisional application No. 61/350,664, filed on Jun. 2, 2010.

(51) Int. Cl. H04N 1/60

(52) U.S. Cl. 358/1.9

(57) ABSTRACT

According to one embodiment, an image processing apparatus includes an image input unit, a tint block reading unit, a display unit, and a transmission unit. The image input unit scans a sheet on which information of a destination is formed in the form of a tint block. The tint block reading unit reads the information of the destination from the tint block image in the scanned image. The display unit displays the information of the destination that is read. The transmission unit transmits the image formed on the sheet to the destination when a transmission instruction is given from an operator who checks the information of the destination.

### CROSS-REFERENCE TO RELATED APPLICATION

This application is based upon and claims the benefit of priority from: U.S. provisional application 61/350,664, filed on Jun. 2, 2010; the entire contents all of which are incorporated herein by reference.

### FIELD

Embodiments described herein relate generally to a technique of preventing erroneous transmission of data.

### BACKGROUND

Transmitting document to others by fax is carried out on a day-to-day basis.

In transmission by fax, mistakes may occur when entering the destination fax number, thus causing erroneous transmission. Techniques of preventing this erroneous transmission include a technique of registering the destination in advance, a technique in which information of the destination is written on the transmission document and the user enters the fax number while checking the information of the destination, and a technique in which the user enters the number twice. In all these techniques, the user is responsible for operation, or operation rule and application rules for the user are provided.

There is also a system such as internet fax in which electronic data created on a PC (personal computer) can be directly faxed without using any paper medium. However, there still are cases where a document is transmitted via a paper medium, for example, where a signature or the like needs to be written on the transmission document before transmission, or a catalog as a paper medium needs to be partly attached before transmission, or the transmission document needs to be saved in the form of a paper medium.

### DESCRIPTION OF THE DRAWINGS

FIG. 1 is a schematic view showing the configuration of a data transmission system according to an embodiment.

FIG. 2 is an exemplary block diagram of a data transmission system according to a first embodiment.

FIG. 3 shows an example of operation of the data transmission system according to the first embodiment.

FIG. 4A shows an example of a sheet with tint block according to an embodiment.

FIG. 4B shows an example of a sheet with tint block according to an embodiment.

FIG. 5 is an exemplary block diagram of a data transmission system according to a second embodiment.

FIG. 6 shows an example of operation of the data transmission system according to the second embodiment.

### DETAILED DESCRIPTION

In general, according to one embodiment, an image processing apparatus includes an image input unit, a tint block reading unit, a display unit, and a transmission unit. The image input unit scans a sheet on which information of a destination is formed in the form of a tint block, and converts a scanned image to an electronic image. The tint block reading unit reads the information of the destination from the tint block image in the electronic image converted by the image input unit. The display unit displays the information of the destination read by the tint block reading unit. The transmission unit transmits the image formed on the sheet to the destination when a transmission instruction is given from an operator who checks the information of the destination displayed on the display unit.

In a data transmission system disclosed in an embodiment, when printing a text of fax from a PC, information of a destination is simultaneously printed as tint block information, and the information of the destination is read at the time of fax transmission and the information of the destination is displayed on a control panel. Thus, input errors and selection errors can be prevented. In the embodiment, a tint block refers to a background or pattern (woven pattern) image formed on a sheet and also includes an image formed in edges or margins on the sheet.

### First Embodiment

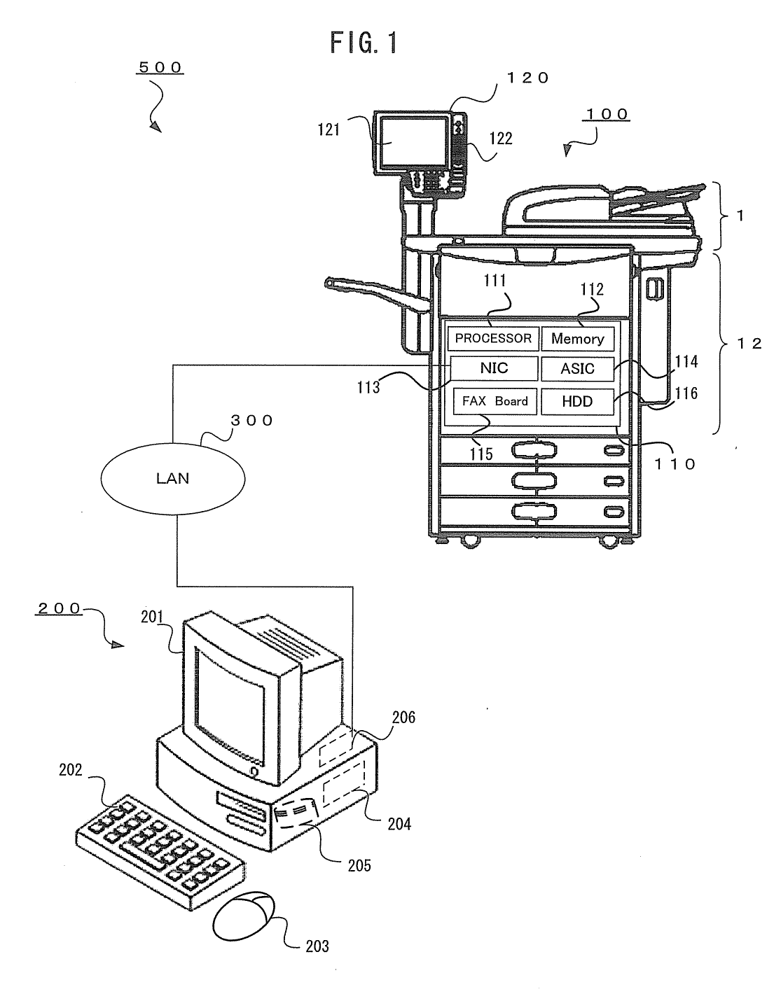

FIG. 1 shows an exemplary configuration of a data transmission system according to an embodiment. A data transmission system 500 has at least one image processing apparatus 100 as an MFP (multi-function peripheral) having a copy function, printer function, scanner function, and a fax and e-mail transmission and receiving function, and at least one PC 200 used by an operator. The image processing apparatus 100 and the PC 200 are connected by a LAN (local area network) 300 and can mutually communicate.

The image processing apparatus 100 has a control board 110 which performs general control of hardware devices within the apparatus. The control board 110 has a processor 111 as an operation processing device, and a memory 112 (page memory) as a volatile storage device. The processor 111 is, for example, a CPU (central processing unit) or MPU (micro processing unit). The memory 112 is, for example, a RAM (random access memory). The control board 110 has a HDD (hard disk drive) 116 in which data is stored in a non-volatile manner, and has a NIC (network interface card) 113 which controls external communication. The control board 110 has a fax board 115 which externally transmits and receives fax signals, and an ASIC (application specific integrated circuit) 114 which executes image processing.

The image processing apparatus 100 has a keyboard 122 to accept user's instructions, and a control panel 120 including a touch panel display 121 to display control contents and accept user's instructions.

The image processing apparatus 100 also has an image input unit 1 which scans an image of a sheet document or book document and converts the image formed on the sheet to an electronic image. The image processing apparatus 100 also has an image forming unit 12 which acquires electronic image data that is externally transmitted thereto or image data converted by the image input unit 1 and forms the image on a sheet.

The hardware configuration of the PC 200 is similar to an existing PC. The PC 200 has a processor 204, a memory 205, and a NIC 206, and also has a keyboard 202 to accept user's inputs, a mouse 203, and a monitor 201 which displays an image to the user. The NIC 113 and the NIC 206 control mutual communication via the LAN 300. The memory 205 is described as including both a volatile storage device and a non-volatile storage device.

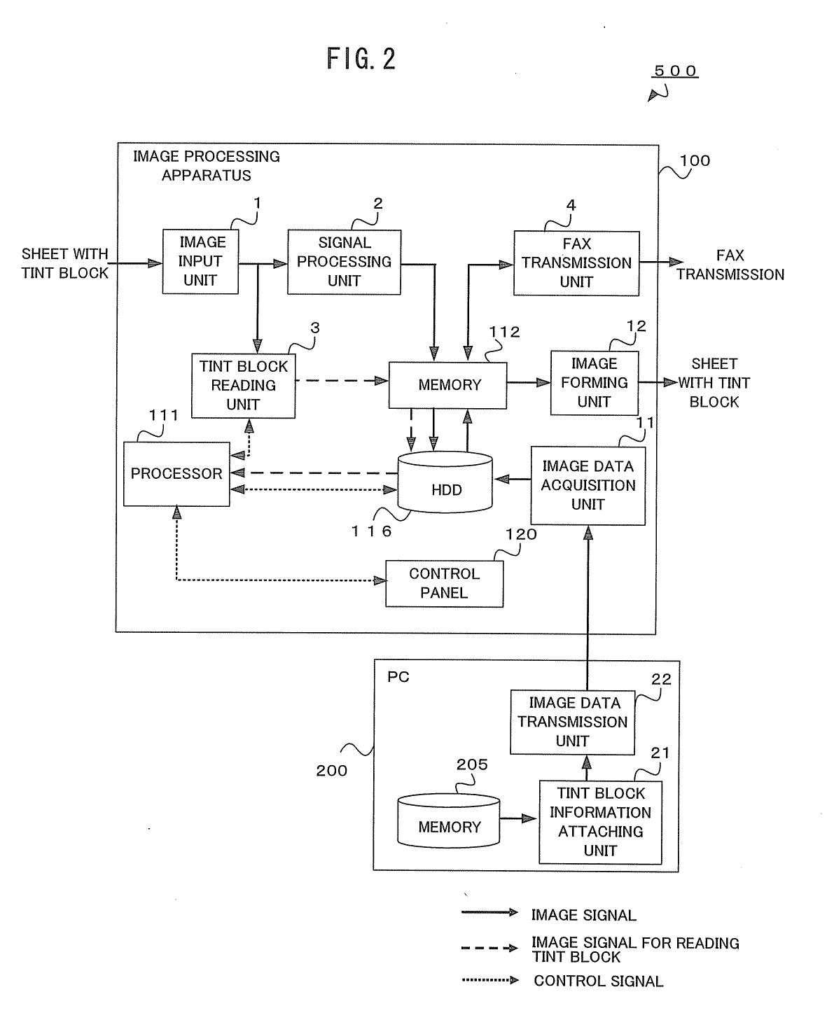

Next, functional blocks of the image processing apparatus 100 and the PC 200 will be described with reference to FIG. 2. The image processing apparatus 100 has a signal processing unit 2, a tint block reading unit 3, a fax transmission unit 4, and an image data acquisition unit 11, in addition to the image input unit 1, the image forming unit 12, the processor 111, the memory 112, the HDD 116, and the control panel 120, which are described above.

The image data acquisition unit 11 is a unit which acquires an electronic image transmitted from the PC 200 and is realized by the NIC 113.

The image forming unit 12 in this embodiment also acquires an electronic image with information of the destination attached in the form of a tint block, via the image data acquisition unit 11, and forms the image on a sheet.

The image input unit 1 in this embodiment also scans the sheet on which the information of the destination is formed in the form of a tint block and converts the scanned image to an electronic image.

The tint block reading unit 3 is a unit which reads the information of the destination from the tint block image in the electronic image converted by the image input unit 1, and is realized by the ASIC 114.

The control panel 120 also displays the information of the destination read by the tint block reading unit 3.

The signal processing unit 2 acquires the electronic image from the image input unit 1 and converts the electronic image to a signal for fax transmission. The fax transmission unit 4 is a unit which executes fax transmission. When a transmission instruction is given by the operator who checks the information of the destination displayed on the control panel 120, the fax transmission unit 4 transmits, to the destination, the data converted to the signal for fax transmission by the signal processing unit 2. The signal processing unit 2 and the fax transmission unit 4 are realized by the fax board 115.

The processor 111 controls these units and also controls data input to and output from the memory 112 and the HDD 116.

The PC 200 has a tint block attaching unit 21 and an image data transmission unit 22. The tint block attaching unit 21 acquires information of a destination selected by the operator from the memory 205, processes the information of the destination into a tint block pattern, and attached the tint block pattern to image data. The tint block information attaching unit 21 is realized as the processor 204 unfolds a program stored in the non-volatile storage area in the memory 205 (for example, driver software of the image processing apparatus 100) to the volatile storage area in the memory 205 and executes operation of the unfolded program.

The image data transmission unit 22 is a unit which transmits the image data with the information of the destination attached, to the image data acquisition unit 11 of the image processing apparatus 100. The image data transmission unit 22 is realized by the NIC 206.

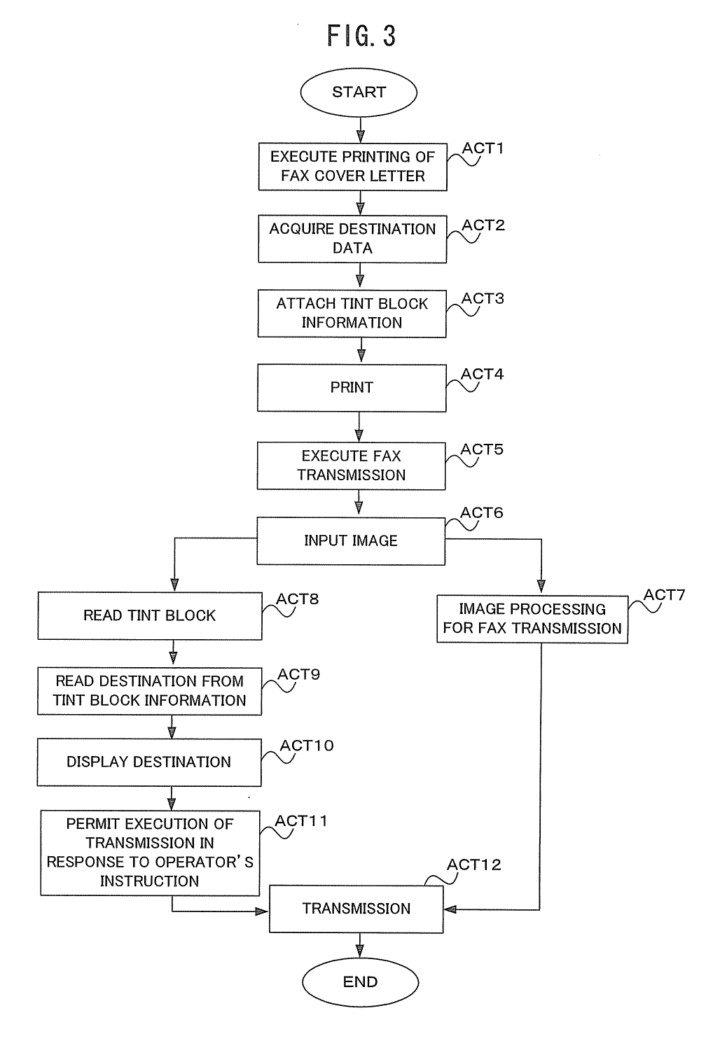

Operation of the data transmission system 500 will be described with reference to the flowchart shown in FIG. 3.

As the operator executes printing of a fax cover letter on the PC 200 (ACT 1), the tint block information attaching unit 21 acquires information of the destination from the memory 205 (ACT 2). A contact address list is registered in the memory 205 in advance. As the operator selects information of one or plural destinations from the contact address list, information of the destination (s) is acquired. The tint block attaching unit 21 carries out image processing of the acquired information of the destination so that this information appears in the form of a tint block on a sheet, and superimposes the processed information on image data of a print target (transmission target) (ACT 3).

Next, the image data with the tint block information attached is printed (ACT 4). The operation in ACT 4 will now be described. The image data with the tint block information attached is transmitted from the PC 200 to the image processing apparatus 100 via the image data transmission unit 22 and the image data acquisition unit 11, and is stored in the HDD 116. After that, the image forming unit 12 acquires the image data from the HDD 116 via the memory 112, then forms the image on a sheet, and outputs the sheet to a tray.

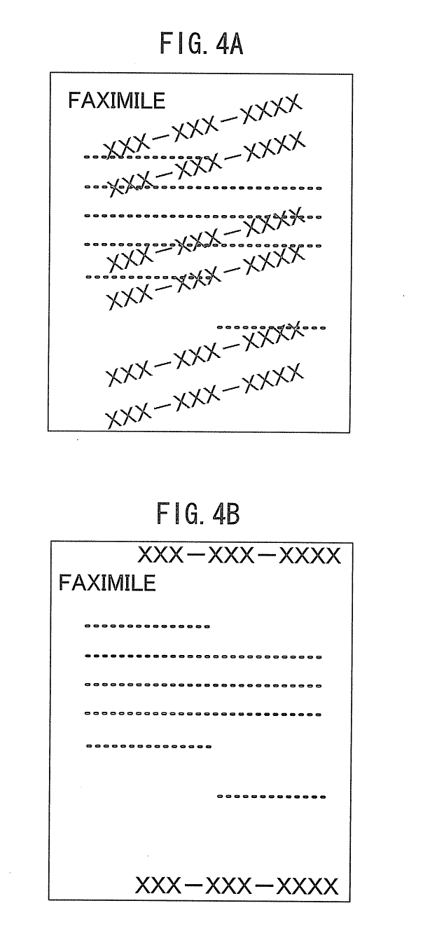

FIG. 4A and FIG. 4B show an example of the sheet outputted by the image forming unit 12. FIG. 4A shows an example in which the fax number (described as “XXX-XXX-XXXX”) of the destination is formed on the sheet as a background image. FIG. 4B shows an example in which the fax number of the destination is formed at top and bottom parts of the sheet. These examples are just exemplars and are not intended to limit the embodiment. The information of the destination may be, for example, the fax number of the destination, the name, company name or department name of the addressee, or identification information which univocally specifies the destination. These pieces of information may also be combined to form the information of the destination.

In the operation up to this point, the operator works on the PC 200. However, in the subsequent operation, the operator works on the image processing apparatus 100. Here, the operator also takes out the printed sheet from the tray, writes a signature or sign, or prepares an attached sheet such as a catalog.

The operator places the sheet with the tint block formed by the image forming unit 12 at a predetermined scanning position in the image input unit 1, and presses a fax transmission button displayed on the control panel 120 (ACT 5). The image input unit 1 scans the sheet placed therein and acquired the electronic image data (ACT 6).

The signal processing unit 2 converts the electronic image data to a signal of a fax transmission format based on an existing technique and stores the signal data of that format into the HDD 116 via the memory 112 (ACT 7). The subsequent processing is on standby until ACT 11 is carried out.

Meanwhile, the tint block reading unit 3 reads the tint block information formed in the electronic image data acquired by the image input unit 1 (the tint block image area and the non-tint block image area are separated and only the tint block image area is thus extracted) (ACT 8). The tint block reading unit 3 acquires the information of the destination from the tint block information (ACT 9). Here, using an existing OCR (optical character reader) technique, text data is acquired from the image data. The text data thus acquired is stored in the HDD 116 via the memory 112.

The control panel 120 acquires and displays the information of the destination (in this example, text data) under the control of the processor 111 (ACT 10). At this point, the control panel 120 also displays a dialog and displays buttons to acquire the result of determination about whether the operator permits or cancels transmission, above the dialog.

Here, when the button to permit transmission is pressed (ACT 11), the fax transmission unit 4 acquires the data for fax transmission created by the signal processing unit 2 in ACT 7, from the HDD 116 via the memory 112, and transmits the data (ACT 12).

In this embodiment, when the button to cancel transmission is pressed in ACT 11, the image forming apparatus 100 does not accept re-input of the destination information. In this case, the fax transmission unit 4 is controlled not to transmit the signal data for fax transmission generated in ACT 7. This control is performed by the processor 111 (control unit). The reason for this control is that there may be an error in the re-input from the operator. This control is an implementation to restrain erroneous transmission as much as possible.

An implementation to accept the re-input from the operator may also be employed. In this case, when an instruction to cancel transmission is given by the operator, the control panel 120 displays an input dialog to accept the information of the destination. The fax transmission unit 4 transmits the signal data for fax transmission generated in ACT 7 to the destination inputted on the input dialog.

Alternatively, as operation in the case where transmission is canceled, an implementation to control whether or not to accept the information of the destination according to a prior setting made by the manager can be employed. This example of implementation will now be described. When transmission is canceled, the processor 111 (control unit) controls whether or not to accept the information of the destination according to the prior setting. When transmission is canceled and the processor 111 performs control to accept the information of the destination, the control panel 120 displays an input dialog and thus accepts the information of the destination. The fax transmission unit 4 transmits the signal data to the destination inputted in the input dialog. Meanwhile, when transmission is canceled and the processor 111 performs control not to accept the information of the destination, the fax transmission unit 4 does not transmit the image formed on the sheet to the destination. In this case, the input dialog is not displayed on the control panel 120.

In ACT 2 of the exemplary operation, the information of the destination is described as being selected and thus acquired from the contact address list registered in the memory 205 in advance. As another example, letting the operator input the information of the destination is possible. In this case, the input dialog for the information of the destination is displayed on the monitor 201. The tint block information attaching unit 21 acquires data inputted by the operator using the keyboard 202, as destination information.

In ACT 2, an implementation may also be employed such that the tint block information attaching unit 21 acquires the information of the destination shown in advance in a predetermined area in the transmission target image data and attaches the information of the destination in the form of a tint block. A technique of acquiring the information of the destination will now be described. When the information of the destination incorporated in the transmission target data is text data, the tint block information attaching unit 21 acquires this text data. When the transmission target data is image data (raster data), the tint block information attaching unit 21 applies an existing OCR technique to acquire the information of the destination. After that, the tint block information attaching unit 21 processes the acquired information of the destination into a tint block pattern and attaches the tint block pattern to the transmission target data (ACT 3).

Thus, in this embodiment, the information of the destination is displayed on the control panel before fax transmission is carried out. Since the operator can check the destination displayed on the control panel, erroneous transmission can be prevented. Moreover, since the destination can be checked at least twice, that is, the check when the destination is selected or inputted on the PC and the check using the system when executing transmission, erroneous transmission can be prevented.

### Second Embodiment

In the first embodiment, the tint block reading unit 3 reads the tint block, using the scanned image generated by the image input unit 1 without any change (see ACT 6 and ACT 8 in FIG. 3). Here, when image data scanned, for example, with 600 dpi or higher resolution is processed, that is, when image data generated by the image input unit 1 is large, the reading by the tint block reading unit 3 takes time. When the reading uses an OCR technique, the reading speed improves while analytic accuracy (pattern match accuracy) does not significantly fall, even if resolution is lowered to, for example, approximately 300 dpi. Thus, in a second embodiment, an example of implementation will be described in which image data generated by the image input unit 1 is reduced and the tint block reading unit 3 reads a tint block from the reduced image.

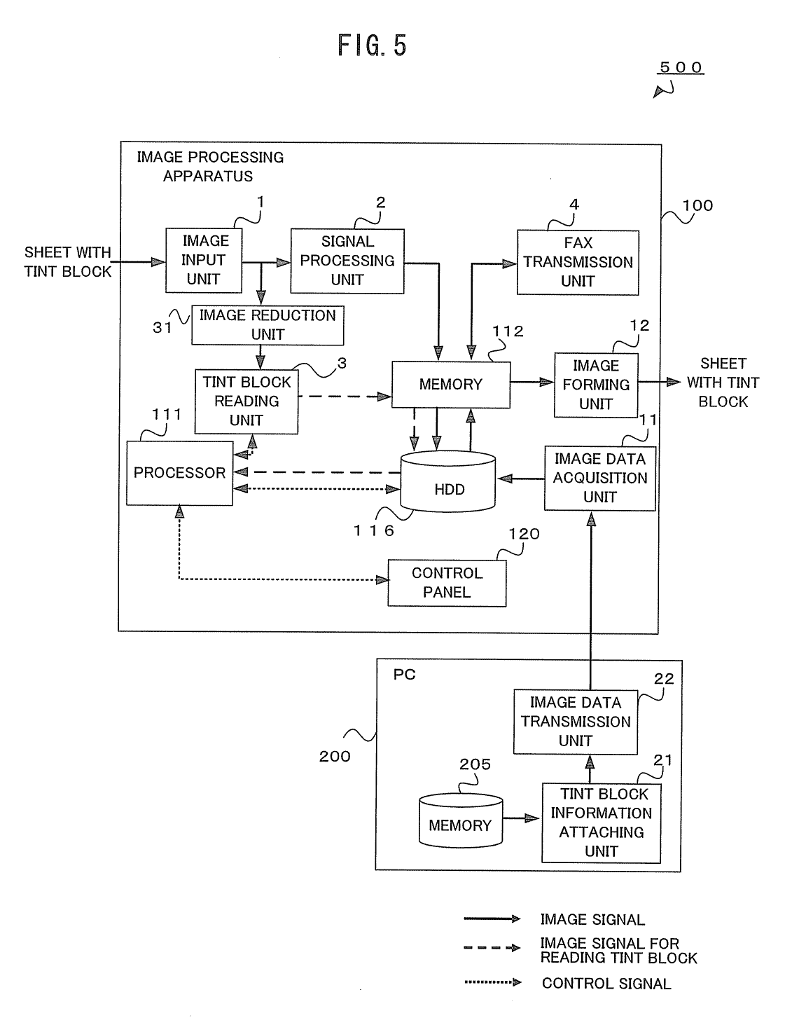

FIG. 5 is a block diagram showing an exemplary configuration of a data transmission system according to the second embodiment. The same reference numerals as in FIG. 2 denote the same elements as in the first embodiment. The system configuration of the second embodiment is similar to the first embodiment (see FIG. 1).

In the second embodiment, an image reduction unit 31 is provided between the image input unit 1 and the tint block reading unit. The image reduction unit 31 is realized by the ASIC 114. The image reduction unit 31 acquires an electronic image from the image input unit 1 and performs processing to reduce the electronic image. The tint block reading unit 3 reads information of the destination from a tint block image in the reduced image created by the image reduction unit 31.

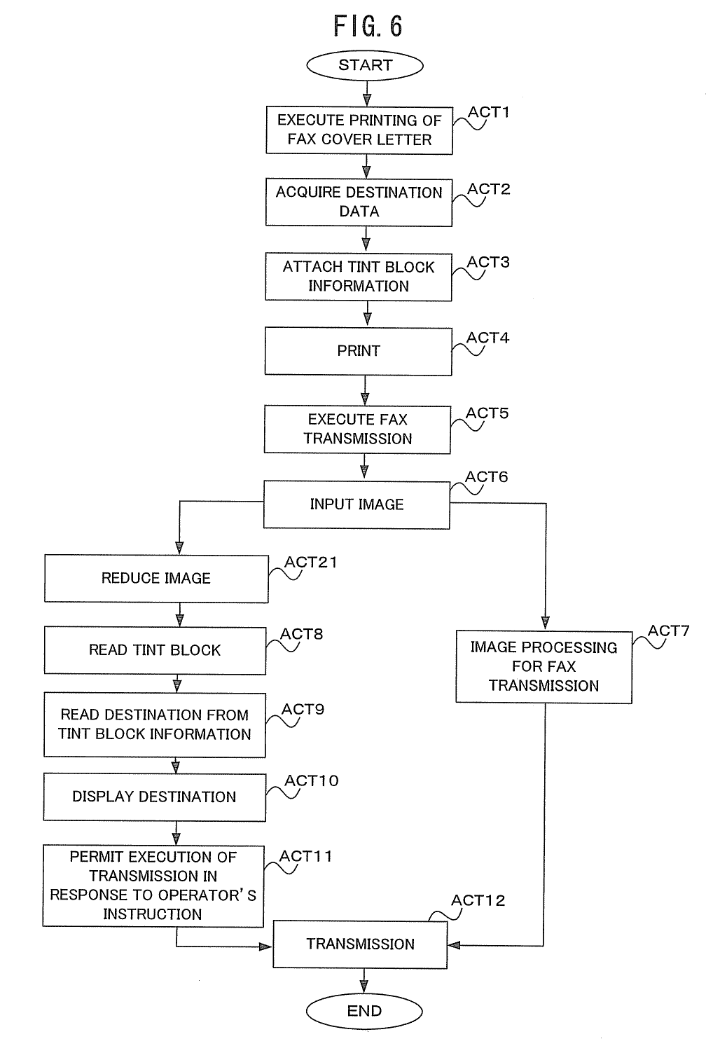

An example of operation of the data transmission system according to the second embodiment is shown in the flowchart of FIG. 6. In the flowchart of FIG. 6, the same reference numerals as in FIG. 3 denote the same operation as in the first embodiment and therefore the description of this operation is omitted.

After the image input unit 1 scans a sheet with tint block and acquires electronic image data (ACT 6), the image reduction unit 31 reduces the electronic image data (ACT 21). There are various reduction techniques, for example, a technique of extracting every other pixel, or a technique of dividing image data into small areas and acquiring an average value within the small areas. The tint block reading unit 3 reads tint block information formed in the electronic image data reduced by the image reduction unit 31 (ACT 8).

In the respective embodiments, the system for fax transmission is described. However, the embodiments are not limited to this system and can be applied to any implementation of a system in which information of a destination is specified and data is transmitted to the destination, such as transmission via e-mail or transmission via FTP (file transfer protocol).

As described above in detail, according to the technique described herein, erroneous transmission of data can be prevented.

While certain embodiments have been described, these embodiments have been presented by way of example only, and are not intended to limit the scope of invention. Indeed, the novel apparatus, systems and methods described herein may be embodied in a variety of other forms; furthermore, various omissions, substitutions and changes in the form of the apparatus, systems and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image input unit which scans a sheet on which information of a destination is formed in the form of a tint block, and converts a scanned image to an electronic image;
a tint block reading unit which reads the information of the destination from the tint block image in the electronic image converted by the image input unit;
a display unit which displays the information of the destination read by the tint block reading unit; and
a transmission unit which transmits the image formed on the sheet to the destination when a transmission instruction is given from an operator who checks the information of the destination displayed on the display unit.

2. The apparatus of claim 1, further comprising an image reduction unit which creates a reduced image by reducing the electronic image converted by the image input unit,
wherein the tint block reading unit reads the information of the destination from the tint block image in the reduced image created by the image reduction unit.

3. The apparatus of claim 1, further comprising a control unit which controls the transmission unit not to perform transmission when an instruction to cancel transmission is given by the operator.

4. The apparatus of claim 1, wherein the display unit further displays an input screen to accept the information of the destination when an instruction to cancel transmission is given by the operator, and
the transmission unit further transmits the image formed on the sheet to the destination inputted on the input screen displayed by the display unit.

5. The apparatus of claim 1, further comprising a control unit which controls whether or not to accept the information of the destination when transmission is canceled,
wherein when the control unit performs control to accept the information of the destination and transmission is canceled, the display unit further displays an input screen to accept the information of the destination, and the transmission unit further transmits the image formed on the sheet to the destination inputted on the input screen displayed by the display unit, and
when the control unit performs control not to accept the information of the destination and transmission is canceled, the transmission unit does not perform transmission.

6. The apparatus of claim 1, wherein the information of the destination is a fax number, and
the transmission unit transmits the image formed on the sheet by fax.

7. The apparatus of claim 1, wherein the information of the destination entered in advance in a predetermined area on the sheet is formed in the form of a tint block on the sheet.

8. A data transmission system comprising at least one image processing apparatus and at least one computer,
the computer comprising:
a tint block information attaching unit which attaches information of a destination in the form of a tint block to image data of a transmission target,
the image processing apparatus comprising:
an image forming unit which forms the image data with the tint block attached, on a sheet;
an image input unit which scans the sheet and converts a scanned image to an electronic image;
a tint block reading unit which reads the information of the destination from the tint block image in the electronic image converted by the image input unit;
a display unit which displays the information of the destination read by the tint block reading unit; and
a transmission unit which transmits the image formed on the sheet to the destination when a transmission instruction is given from an operator who checks the information of the destination displayed on the display unit.

9. The system of claim 8, wherein the image processing apparatus further comprises an image reduction unit which creates a reduced image by reducing the electronic image converted by the image input unit, and
the tint block reading unit reads the information of the destination from the tint block image in the reduced image created by the image reduction unit.

10. The system of claim 8, wherein the image processing apparatus further comprises a control unit which controls the transmission unit not to perform transmission when an instruction to cancel transmission is given by the operator.

11. The system of claim 8, wherein the display unit further displays an input screen to accept the information of the destination when an instruction to cancel transmission is given by the operator, and
the transmission unit further transmits the image formed on the sheet to the destination inputted on the input screen displayed by the display unit.

12. The system of claim 8, wherein the image processing apparatus further comprises a control unit which controls whether or not to accept the information of the destination when transmission is canceled,
when the control unit performs control to accept the information of the destination and transmission is canceled, the display unit further displays an input screen to accept the information of the destination, and the transmission unit further transmits the image formed on the sheet to the destination inputted on the input screen displayed by the display unit, and
when the control unit performs control not to accept the information of the destination and transmission is canceled, the transmission unit does not perform transmission.

13. The system of claim 8, wherein the information of the destination is a fax number, and
the transmission unit transmits the image formed on the sheet by fax.

14. The system of claim 8, wherein the tint block information attaching unit further attaches the information of the destination entered in advance in a predetermined area of the image data of the transmission target, in the form of a tint block.

15. An image processing method comprising:
an image processing apparatus
scanning a sheet on which information of a destination is formed in the form of a tint block, and converting a scanned image to an electronic image;
reading the information of the destination from the tint block image in the electronic image;
displaying the information of the destination that is read; and
transmitting the image formed on the sheet to the destination when a transmission instruction is given from an operator who checks the information of the destination that is displayed.

16. The method of claim 15, wherein the image processing apparatus further
creates a reduced image by reducing the electronic image, and
reads the information of the destination from the tint block image in the reduced image.

17. The method of claim 15, wherein the image processing apparatus further performs control not to transmit the image formed on the sheet to the destination when an instruction to cancel transmission is given by the operator.

18. The method of claim 15, wherein the image processing apparatus further
displays an input screen to accept the information of the destination when an instruction to cancel transmission is given by the operator, and
transmits the image formed on the sheet to the destination inputted on the input screen.

19. The method of claim 15, wherein the image processing apparatus further
comprises a control unit which controls whether or not to accept the information of the destination when transmission is canceled,
displays an input screen to accept the information of the destination and transmits the image formed on the sheet to the destination inputted on the input screen, when the control unit performs control to accept the information of the destination and transmission is canceled, and
does not transmit the image formed on the sheet to the destination when the control unit performs control not to accept the information of the destination and transmission is canceled.

20. The method of claim 15, wherein the information of the destination is a fax number, and
the image processing apparatus transmits the image formed on the sheet by fax.
